(19) United States
(12) Patent Application Publication
(10) Pub. No.: US 2017/0060296 A1
(43) Pub. Date: Mar. 2, 2017

(54) Touch Display Apparatus

(71) Applicant: Top Victory Investments Ltd., Kowloon (HK)

(72) Inventors: Wen-Chun WANG, New Taipei City (TW); Chien-Liang CHOU, New Taipei City (TW); Yi-Chun WU, New Taipei City (TW); Po-Hsien WANG, New Taipei City (TW)

(21) Appl. No.: 14/927,623

(22) Filed: Oct. 30, 2015

(30) Foreign Application Priority Data
Sep. 1, 2015 (CN) 201510550321.3

(51) Int. Cl. G06F 3/044

(52) U.S. Cl. CPC G06F 3/044

(57) ABSTRACT

The invention provides a touch display apparatus including a first polarizer, a display panel disposed on the first polarizer, a gap disposed on the display panel, and a second polarizer disposed on the gap. The touch display apparatus further includes a cover lens disposed on the outermost surface of the touch display apparatus with respect to the first polarizer. The invention also provides an electric apparatus including the above-mentioned touch display apparatus. The invention can preferably solve the problem of the poor visibility of the air bonding touch display apparatus in the prior art.

### BACKGROUND OF THE INVENTION

1. Field of the Invention

The invention relates to a display apparatus, and especially relates to a touch display apparatus.

2. Description of the Prior Art

The described touch display apparatus includes the capacitive, resistive, or electromagnetic induction type, especially the capacitive type.

Please refer to FIGS. 1 and 2. FIG. 1 is the direct bonding touch display apparatus in the prior art, and FIG. 2 is the air bonding touch display apparatus in the prior art.

The touch display apparatus in the prior art includes a touch panel and a display panel. The bonding of the touch panel and the display panel employs the direct bonding or air bonding technology. The cost of the air bonding touch display apparatus is lower than that of the direct bonding touch display apparatus.

The structure of the direct bonding touch display apparatus 11a in the prior art in FIG. 1, in the cross section from the top toward the bottom, includes: a touch panel 6, an Optically Clear Adhesive (OCA) 10, a second polarizer 5, a display panel 3, and a first polarizer 2. The light transmission rate of the direct bonding touch display apparatus is about 96%, and the reflectance of that is about 4%.

The structure of the air bonding touch display apparatus 11b in the prior art in FIG. 2, in the cross section from the top toward the bottom, includes: a touch panel 6, a gap 4 (an air gap in FIG. 2), a second polarizer 5, a display panel 3, and a first polarizer 2. The light transmission rate of the air bonding touch display apparatus is about 88%, and the reflectance of that is about 12%, i.e., 4%+4%+4%=12%.

In the strong ambient light environment, the 12% reflectance of the air bonding touch display apparatus 11b is triple of the 4% reflectance of the direct bonding touch display apparatus 11a. That is to say, the wash-out phenomenon of the air bonding touch display apparatus 11b is triple of that of the direct bonding touch display apparatus 11a.

Thus, the cost is lower if the air bonding touch display apparatus 11b is used, but there is the gap 4 (here is the air gap) between the touch panel 6 and the display panel 3, and therefore there are two additional reflection interfaces which result in the stronger reflection light and cause the bad picture quality with the wash-out to lower the contrast. It is so called the poor outdoor visibility.

In view of this problem, the invention provides the following idea to solve the problem of the poor visibility of the air bonding touch display apparatus 11b in the prior art.

### SUMMARY OF THE INVENTION

The objective of the invention is to solve the problem of the poor visibility of the air bonding touch display apparatus in the prior art by reducing the interface reflection of the touch panel and the display panel generated in the structure of the air bonding touch display apparatus to achieve the better display quality in the strong ambient light environment and also to promote the strength of the touch panel.

For the purpose as described above, there is provided a touch display apparatus including a first polarizer, a display panel disposed on the first polarizer, a gap disposed on the display panel, and a second polarizer disposed on the gap.

According to one embodiment of the invention, the touch display apparatus further includes a touch panel disposed on the second polarizer, and the touch panel includes at least a substrate and a sensor disposed on the substrate. Moreover, the touch display apparatus further includes a cover lens disposed on the outermost surface of the touch display apparatus with respect to the first polarizer. The sensor may be disposed between the cover lens and the substrate or may be disposed between the second polarizer and the substrate.

According to one embodiment of the invention, the touch display apparatus further includes a touch panel disposed between the gap and the second polarizer, and the touch panel includes at least a substrate and a sensor disposed on the substrate. Moreover, the touch display apparatus further includes a cover lens disposed on the outermost surface of the touch display apparatus with respect to the first polarizer. The sensor may be disposed between the second polarizer and the substrate, or may be disposed between the gap and the substrate.

According to one embodiment of the invention, the touch display apparatus further includes a touch panel disposed on the second polarizer, and the touch panel is a sensor disposed on the surface of the second polarizer with the second polarizer as a substrate.

According to one embodiment of the invention, the touch display apparatus further includes a touch panel disposed between the gap and the second polarizer, and the touch panel is a sensor disposed on the surface of the second polarizer with the second polarizer as a substrate.

According to one embodiment of the invention, the touch display apparatus further includes a touch panel disposed between the display panel and the gap. The touch panel includes at least a substrate and a sensor disposed on the substrate.

According to one embodiment of the invention, the touch display apparatus further includes a touch panel disposed inside the display panel, and the touch panel is a sensor integrated inside the display panel.

According to one embodiment of the invention, the material of sensor includes a transparent conductive electrode made of ITO, IZO, silver nanomaterial, metal mesh, and carbon nanotube. The substrate is made of optically transparent, low retardation, or zero retardation material including ITO Glass, Arton film, PC Film, glass, COP, COC, PC, PMMA, PI, PEN, PET, or TAC. The material of cover lens is a glass, a protecting film, a plastic film, or a plastic plate.

### BRIEF DESCRIPTION OF THE DRAWINGS

FIG. 1 is the structural drawing of the direct bonding touch display apparatus in the prior art.

FIG. 2 is the structural drawing of the air bonding touch display apparatus in the prior art.

FIG. 3 to FIG. 10 are the structural drawings of the touch display apparatuses according to the first to eighth embodiments of the invention, respectively.

FIG. 11 and FIG. 12 are the structural drawings of the touch panels according to two embodiments of the invention, respectively.

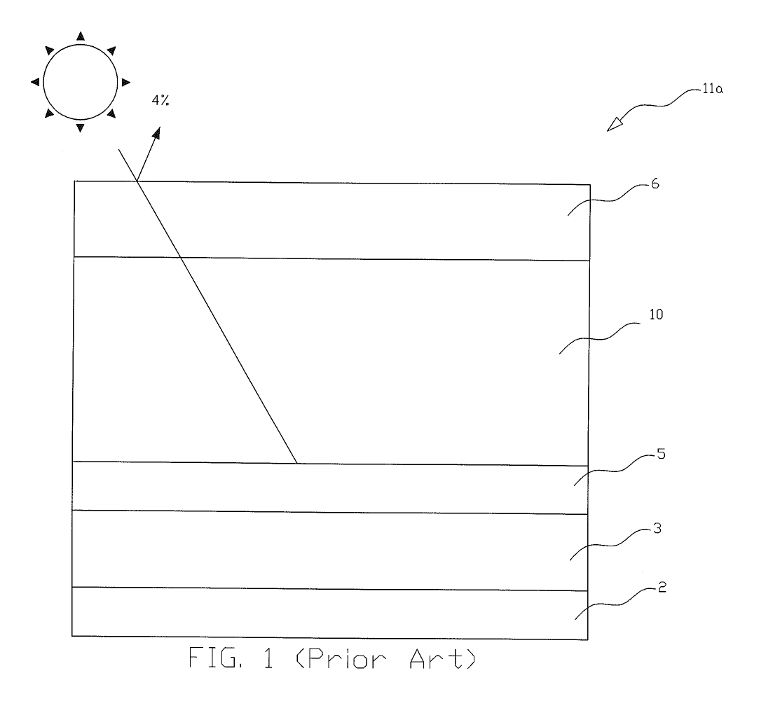

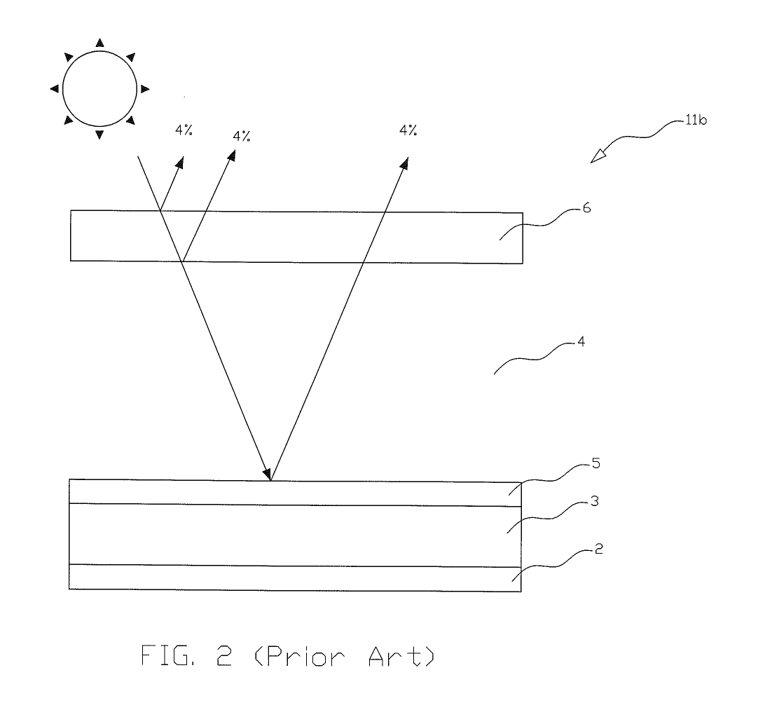

### DESCRIPTION OF THE PREFERRED EMBODIMENTS

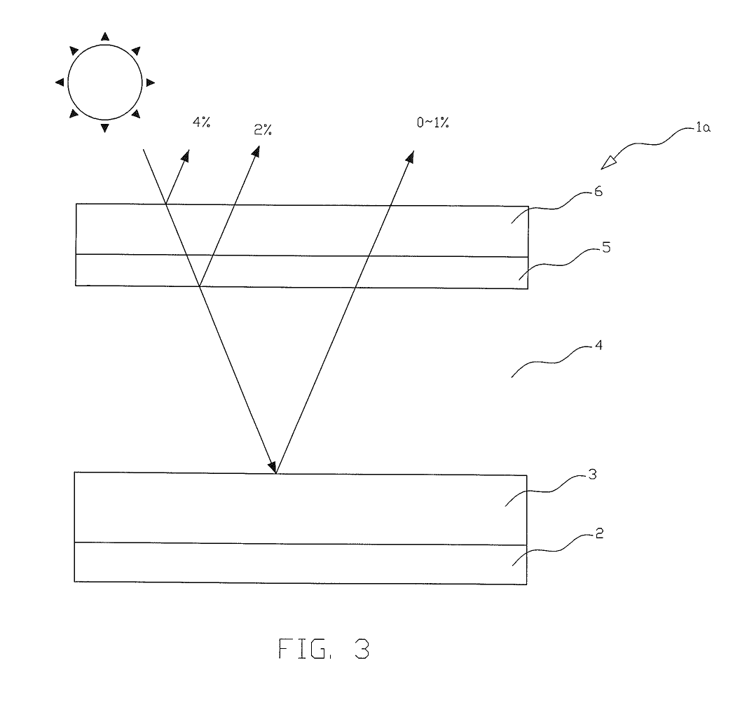

Please refer to FIG. 3 to FIG. 10. The invention relates a touch display apparatus 1a, 1b, 1c, 1d, 1e, 1f, 1g, or 1h including a first polarizer 2, a display panel 3 disposed on the first polarizer 2, a gap 4 disposed on the display panel 3, and a second polarizer 5 disposed on the gap 4.

The first polarizer 2 includes a first polarizing direction, the second polarizer 5 includes a second polarizing direction, and the first polarizing direction is aligned with the second polarizing direction to show an image. For example, if the display panel is a traditional TN, VA, FFS, or IPS LCD, then the second polarizing direction will usually be perpendicular to the first polarizing direction. In the real situation, the first polarizer 2 can be a linear polarizer or a circular polarizer, and the second polarizer 5 can be a linear polarizer or a circular polarizer. The circular polarizer can be composed with a linear polarizer and a quarter-wave plate.

The gap 4 is an air gap of high transparency.

Please refer to FIG. 3. The touch display apparatus 1a further includes a touch panel 6 disposed on the second polarizer 5. The second polarizer 5 can be a linear polarizer or a circular polarizer. If the second polarizer 5 is a circular polarizer, then the reflectance can be even lower.

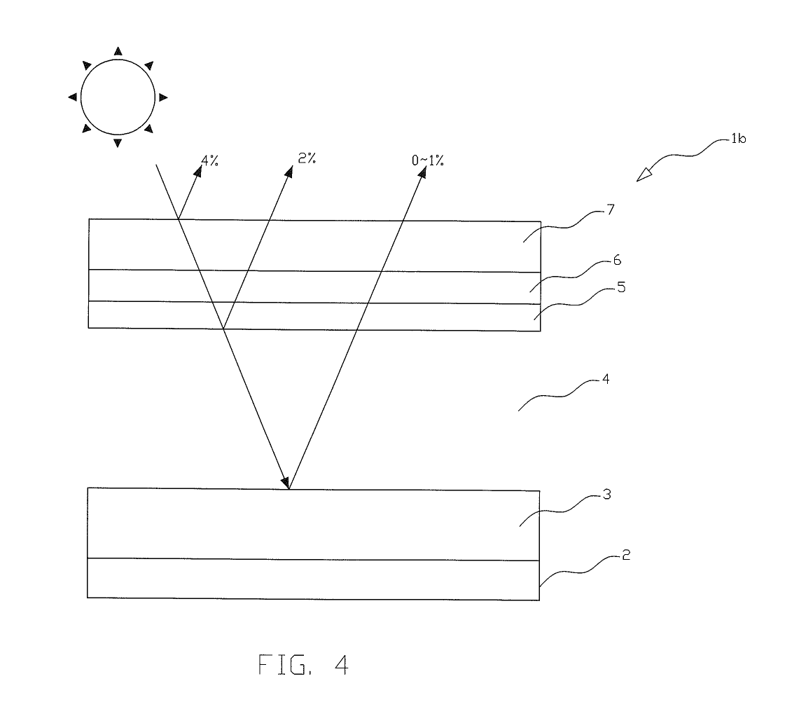

Please refer to FIG. 4. Compared to the touch display apparatus 1a, the touch display apparatus 1b further includes a cover lens 7 disposed on the outermost surface of the touch display apparatus 1b with respect to the first polarizer 2.

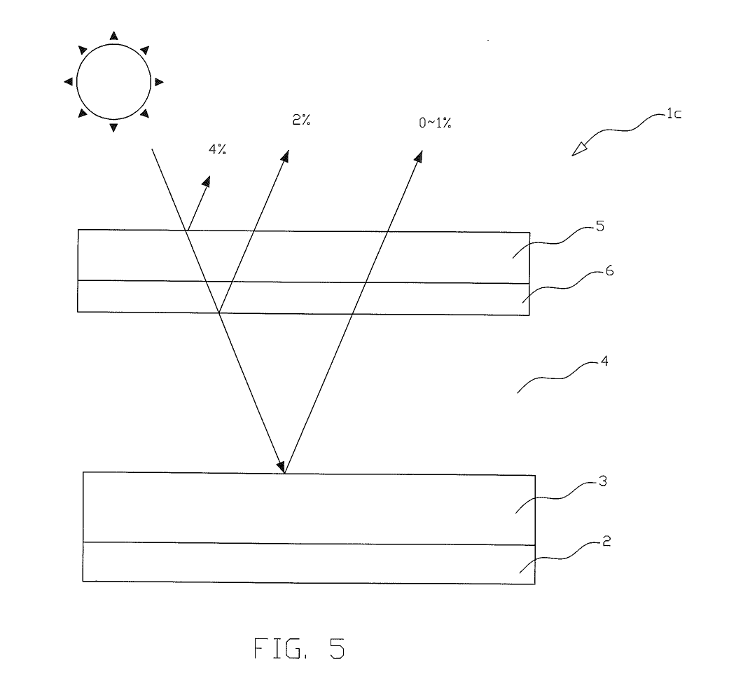

Please refer to FIG. 5. The touch display apparatus 1c further includes a touch panel 6 disposed between the gap 4 and the second polarizer 5. The second polarizer 5 can be a linear polarizer or a circular polarizer. If the second polarizer 5 is a circular polarizer, then the reflectance can be even lower.

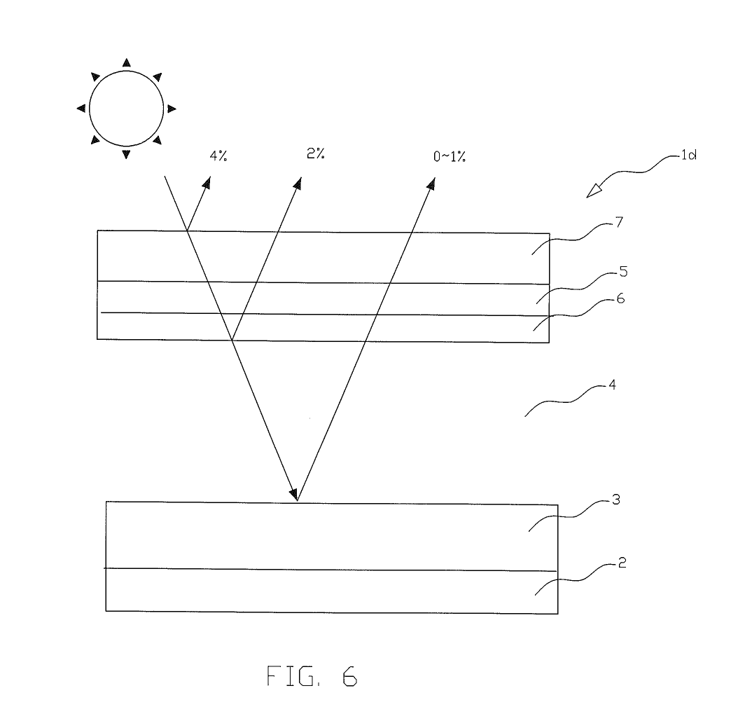

Please refer to FIG. 6. Compared to the touch display apparatus 1c, the touch display apparatus 1d further includes a cover lens 7 disposed on the outermost surface of the touch display apparatus 1d with respect to the first polarizer 2.

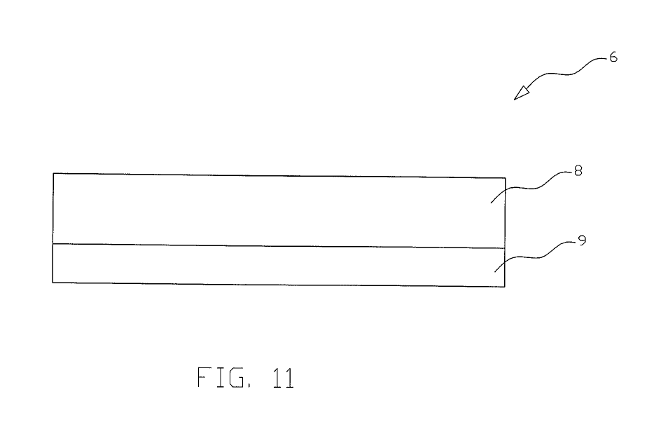

The touch panel 6 as described in FIG. 3 to FIG. 6, referring to FIG. 11, includes at least a substrate 9 and a sensor 8 disposed on the substrate 9. The substrate 9 is made of optically transparent, low retardation, or zero retardation material, especially among ITO Glass, Arton film, PC Film, glass, COP, COC, PC, PMMA, PI, PEN, PET, or TAC. The sensor 8 includes a transparent conductive electrode (not shown in the figures), and the transparent conductive electrode is made of ITO, IZO, silver nanomaterial, metal mesh, and carbon nanotube.

The cover lens 7 as described in FIG. 4 and FIG. 6 is a glass, a protecting film, a plastic film, or a plastic plate. When the cover lens 7 is plastic film, it is generally called the Plastic Cover Lens.

Please refer to FIG. 4 and FIG. 11 together. The touch panel 6 includes at least a substrate 9 and a sensor 8 disposed on the substrate 9. The sensor 8 includes one or more layers of transparent conductive electrodes, and the transparent conductive electrode is made of ITO, IZO, silver nanomaterial, metal mesh, and carbon nanotube. The sensor 8 is formed on the substrate 9 by the thin film process or thick film process, and then bonded onto the cover lens 7; therefore, the sensor 8 is disposed between the cover lens 7 and the substrate 9. The advantage of this method is that, the location of the sensor 8 is closer to the place that the fingers touch, which preferably enhances the touch sensitivity of the touch display apparatus.

If the sensor 8 is disposed on the other side away from the cover lens 7, that is to say, the substrate 9 is between the cover lens 7 and the sensor 8, then the advantage is that, when the touch panel 6 is bonded to the cover lens 7, the sensor 8 has already been protected by the substrate 9 to avoid the direct contacting with the hard cover lens 7, and therefore avoid the risk of scratch during processing.

Please refer to FIG. 6 and FIG. 11 together. The touch panel 6 includes at least a substrate 9 and a sensor 8 disposed on the substrate 9. The sensor 8 includes one or more layers of transparent conductive electrodes, and the transparent conductive electrode is made of ITO, IZO, silver nanomaterial, metal mesh, and carbon nanotube. The sensor 8 is formed on the substrate 9 by the thin film process or thick film process, and then bonded onto the second polarizer 5; therefore, the sensor 8 is disposed between the second polarizer 5 and the substrate 9. The advantage of this method is that, when the touch panel 6 with the second polarizer 5 is bonded to the cover lens 7, the sensor 8 has already been protected by the second polarizer 5 to avoid the direct contacting with the cover lens 7, and therefore avoid the risk of scratch during processing.

If the sensor 8 is disposed on the other side away from the second polarizer 9, that is to say, the substrate 9 is between the second polarizer 5 and the sensor 8, then the advantage is that, the sensor 8 contacts with the air in the air gap 4, there is no need to worry about the risk of the damage of the pressing of the sensor 8.

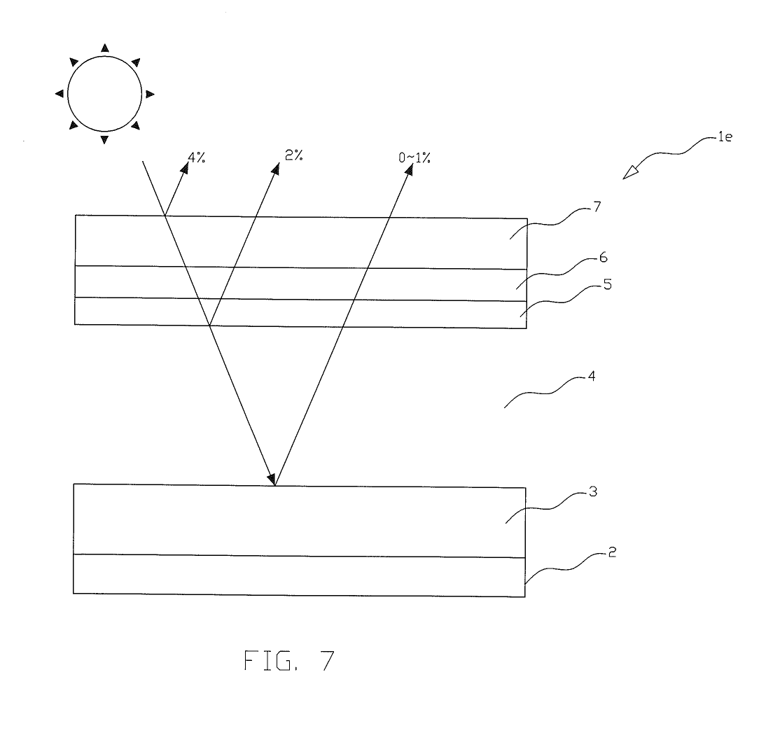

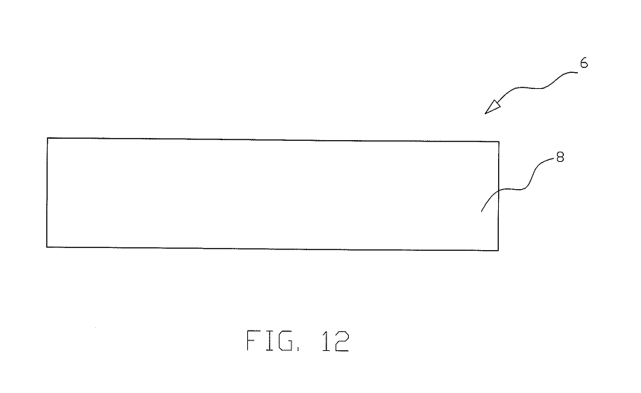

Please refer to FIG. 7. The touch display apparatus 1e further includes a touch panel 6 disposed on the second polarizer 5. The touch panel 6, referring to FIG. 12, is a sensor 8. The sensor 8 is disposed on the surface of the second polarizer 5 with the second polarizer 5 as a substrate. The sensor 8 includes one or more layers of transparent conductive electrodes, and the transparent conductive electrode is made of ITO, IZO, silver nanomaterial, metal mesh, and carbon nanotube. In the embodiment, the touch display apparatus 1e further includes the cover lens 7, but in another embodiment may NOT include the cover lens 7.

Now FIG. 4 and FIG. 7 are described again. The touch panel 6 in FIG. 4 is drawn in FIG. 11, so the touch panel 6 in FIG. 4 includes at least a substrate 9 and a sensor 8 disposed on the substrate 9. The touch panel 6 in FIG. 7 is drawn in FIG. 12, so the touch panel 6 in FIG. 7 includes the sensor 8 only, and do NOT include a substrate 9; moreover, the sensor 8 is disposed on the surface of the second polarizer 5, i.e., the sensor 8 uses the second polarizer 5 as a base, a foundation, or a substrate to form itself on the second polarizer 5.

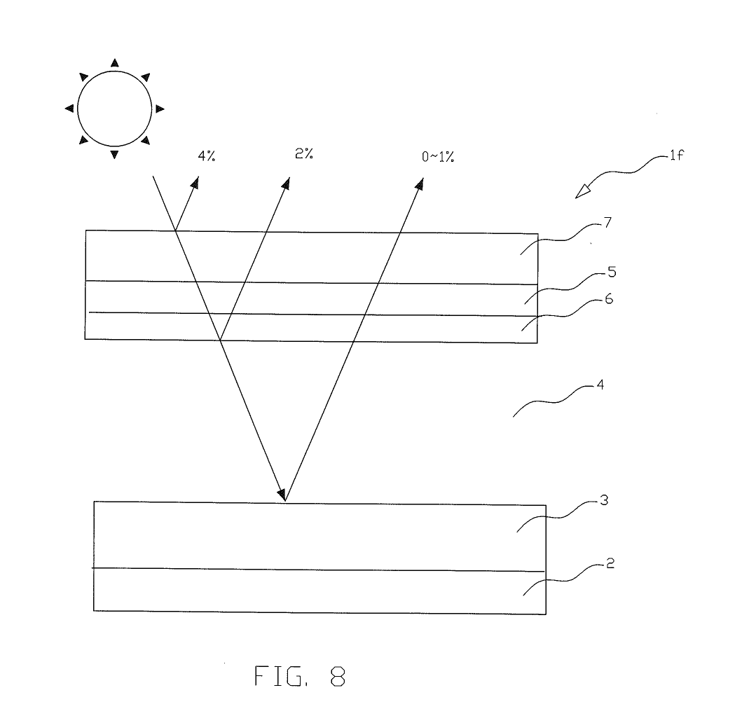

Please refer to FIG. 8. The touch display apparatus if further includes a touch panel 6 disposed between the gap 4 and the second polarizer 5. The touch panel 6, referring to FIG. 12, is a sensor 8. The sensor 8 is disposed on the surface of the second polarizer 5 with the second polarizer 5 as a substrate. The sensor 8 includes one or more layers of transparent conductive electrodes, and the transparent conductive electrode is made of ITO, IZO, silver nanomaterial, metal mesh, and carbon nanotube. In the embodiment, the touch display apparatus if further includes the cover lens 7, but in another embodiment may NOT include the cover lens 7.

Now FIG. 6 and FIG. 8 are described again. The touch panel 6 in FIG. 6 is drawn in FIG. 11, so the touch panel 6 in FIG. 6 includes at least a substrate 9 and a sensor 8 disposed on the substrate 9. The touch panel 6 in FIG. 8 is drawn in FIG. 12, so the touch panel 6 in FIG. 8 includes the sensor 8 only, and do NOT include a substrate 9; moreover, the sensor 8 is disposed on the surface of the second polarizer 5, i.e., the sensor 8 uses the second polarizer 5 as a base, a foundation, or a substrate to form itself on the second polarizer 5.

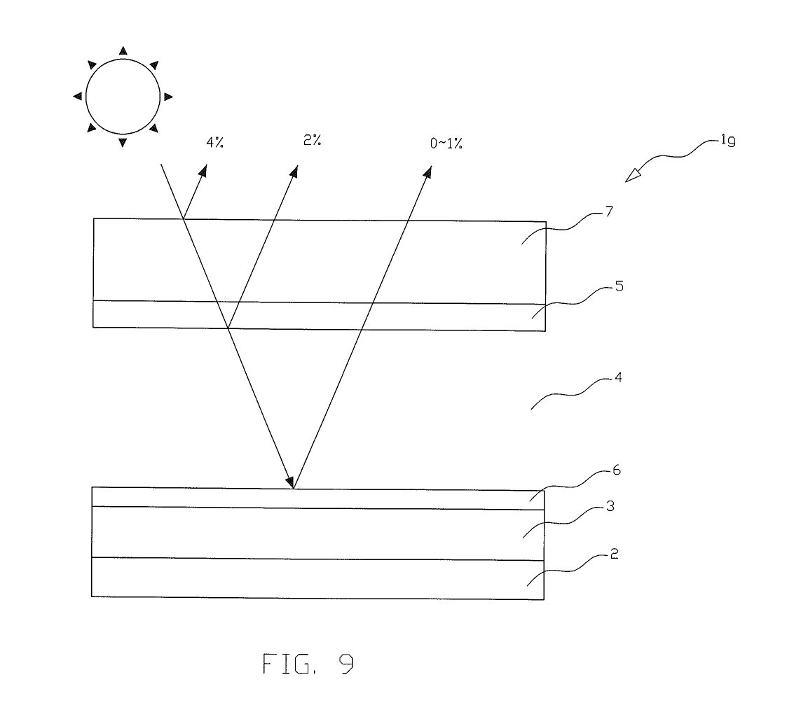

Please refer to FIG. 9. The touch display apparatus 1g further includes a touch panel 6 disposed between the display panel 3 and the gap 4. In one embodiment, referring to FIG. 11, the touch panel 6 includes at least a substrate 9 and a sensor 8 disposed on the substrate 9. The sensor 8 includes one or more layers of transparent conductive electrodes, and the transparent conductive electrode is made of ITO, IZO, silver nanomaterial, metal mesh, and carbon nanotube. The sensor 8 is formed on the substrate 9 by the thin film process or thick film process. In another embodiment, referring to FIG. 12, the touch panel 6 is a sensor 8, and it can be made of ITO, IZO, silver nanomaterial, metal mesh, and carbon nanotube.

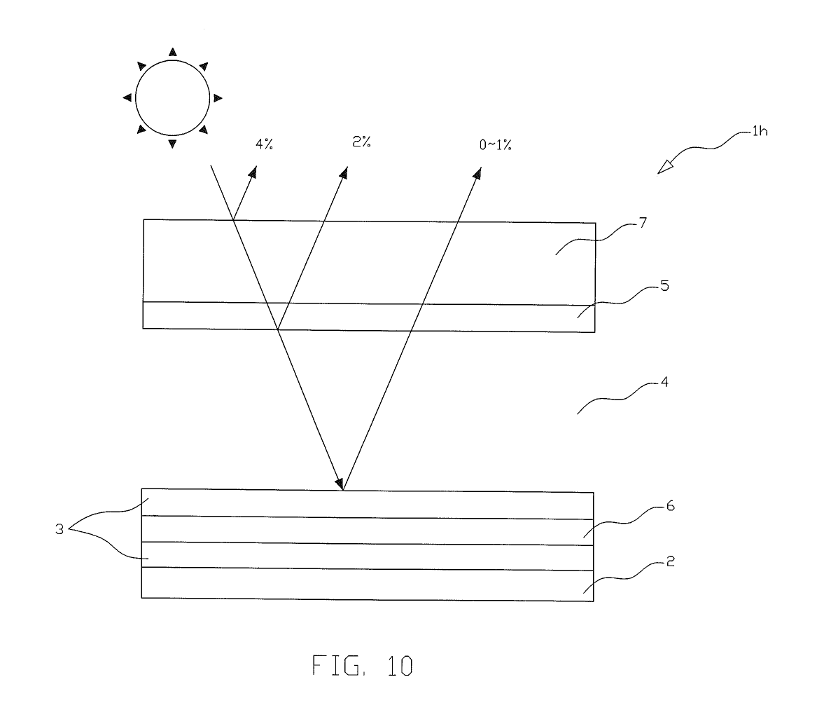

Please refer to FIG. 10. The touch display apparatus 1h, the touch panel 6 is a sensor 8 as in FIG. 12, and the sensor 8 is integrated in the display panel. The sensor 8 includes one or more layers of transparent conductive electrodes, and the transparent conductive electrode is made of ITO, IZO, silver nanomaterial, metal mesh, and carbon nanotube. The sensor 8 is formed in the display panel 3 by the thin film process or thick film process. In the embodiment, the touch display apparatus 1h further includes the cover lens 7, but in another embodiment may NOT include the cover lens 7.

Besides, in FIG. 3 to FIG. 10, the reflectances are noted for the ambient light to contact with each layer. The touch panel 6, the second polarizer 5, the display panel 3, and the cover lens 7 are assumed to have the reflectance of 1.5 and be transparent. Please refer to FIG. 3. (1) the ambient light passes through the air and then contacts with the touch panel 6 first with the reflectance about 4%; (2) the ambient light then enters the touch panel 6 and the second polarizer 5, and then contacts with the gap 4 (air gap), because the second polarizer 5 has absorbed about half of the ambient light, thus the reflectance that the ambient light reaches the exterior through the touch panel 6 is about 2%; (3) then, the ambient light contacts with the display panel 3 through the gap 4 to generate the third reflection, assuming there's depolarization, half of third reflection then is absorbed by the second polarizer 5, then this reflected light passes through the touch panel 6 to enter the exterior, if the second polarizer 5 is linear polarizer, then the reflectance toward the exterior is about 1%. If the second polarizer 5 is circular polarizer, assuming no depolarization of third reflection, then the reflectance toward the exterior is about 0%.

Please refer to FIG. 4. (1) the ambient light passes through the air and then contacts with the cover lens 7 with the reflectance about 4%; (2) then the ambient light enters the cover lens 7, the touch panel 6, and the second polarizer 5, and then contacts with the gap 4 (air gap), because half of the ambient light has been absorbed by the second polarizer 5, thus the reflectance that the ambient light reaches to the exterior through the touch panel 6 and the cover lens 7 is about 2%; (3) then the ambient light contacts with the display panel 3 through the gap 4 to generate the third reflection, assuming there's depolarization, half of the reflection is absorbed by the second polarizer 5, and then the ambient light reaches to the exterior through the touch panel 6 and the cover lens 7, if the second polarizer 5 is linear polarizer, then the reflectance toward the exterior is about 1%. If the second polarizer 5 is circular polarizer, assuming no depolarization of third reflection, then the reflectance toward the exterior is about 0%.

Please refer to FIG. 5. (1) the ambient light passes through the air and then contacts with the second polarizer 5 first with the reflectance about 4%; (2) the ambient light then enters the second polarizer 5 and the touch panel 6, and then contacts with the gap 4 (air gap), because the second polarizer 5 has absorbed about half of the ambient light, thus the reflectance that the ambient light reaches the exterior through the second polarizer 5 is about 2%; (3) then, the ambient light contacts with the display panel 3 through the gap 4 to generate the third reflection, then this reflected light passes through the touch panel 6 and the second polarizer 5, assuming there's depolarization, half of third reflection then is absorbed by the second polarizer 5. Then the ambient light enters the exterior, if the second polarizer 5 is linear polarizer, then the reflectance toward the exterior is about 1%, if the second polarizer 5 is circular polarizer, assuming no depolarization of third reflection, then the reflectance toward the exterior is about 0%.

Please refer to FIG. 6. (1) the ambient light passes through the air and then contacts with the cover lens 7 with the reflectance about 4%; (2) then the ambient light enters the cover lens 7, the second polarizer 5, and the touch panel 6, and then contacts with the gap 4 (air gap), because half of the ambient light has been absorbed by the second polarizer 5, thus the reflectance that the ambient light reaches to the exterior through the touch panel 6, the second polarizer 5, and the cover lens 7 is about 2%; (3) then the ambient light contacts with the display panel 3 through the gap 4 to generate the third reflection, the reflected light passes through the touch panel 6 and the second polarizer 5, assuming there's depolarization, half of the reflection is absorbed by the second polarizer 5, and then the ambient light reaches to the exterior through the cover lens 7, if the second polarizer 5 is linear polarizer, then the reflectance toward the exterior is about 1%. If the second polarizer 5 is circular polarizer, assuming no depolarization of third reflection, then the reflectance toward the exterior is about 0%.

Please refer to FIG. 7. (1) the ambient light passes through the air and then contacts with the cover lens 7 with the reflectance about 4%; (2) then the ambient light enters the cover lens 7, the touch panel 6 (here is a sensor 8 disposed on the second polarizer 5 with the second polarizer 5 as the substrate), and the second polarizer 5, and then contacts with the gap 4 (air gap), because half of the ambient light has been absorbed by the second polarizer 5, thus the reflectance that the ambient light reaches to the exterior through the touch panel 6 and the cover lens 7 is about 2%; (3) then the ambient light contacts with the display panel 3 through the gap 4 to generate the third reflection, assuming there's depolarization, half of the reflection is absorbed by the second polarizer 5, and then the ambient light reaches to the exterior through the touch panel 6 and the cover lens 7, if the second polarizer 5 is linear polarizer, then the reflectance toward the exterior is about 1%. If the second polarizer 5 is circular polarizer, assuming no depolarization of third reflection, then the reflectance toward the exterior is about 0%.

Please refer to FIG. 8. (1) the ambient light passes through the air and then contacts with the cover lens 7 with the reflectance about 4%; (2) then the ambient light enters the cover lens 7, the second polarizer 5, and touch panel 6 (here is a sensor 8 disposed on the second polarizer 5 with the second polarizer 5 as the substrate), and then contacts with the gap 4 (air gap), because half of the ambient light has been absorbed by the second polarizer 5, thus the reflectance that the ambient light reaches to the exterior through the touch panel 6, the second polarizer 5, and the cover lens 7 is about 2%; (3) then the ambient light contacts with the display panel 3 through the gap 4 to generate the third reflection, the reflected light passes through the touch panel 6 and the second polarizer 5, assuming there's depolarization, half of the reflection is absorbed by the second polarizer 5, and then the ambient light reaches to the exterior through the cover lens 7, if the second polarizer 5 is linear polarizer, then the reflectance toward the exterior is about 1%. If the second polarizer 5 is circular polarizer, assuming no depolarization of third reflection, then the reflectance toward the exterior is about 0%.

Please refer to FIG. 9. (1) the ambient light contacts with the cover lens 7 through the air first with the reflectance of about 4%; (2) then the ambient light enters the second polarizer 5 and the gap 4 (air gap), because the second polarizer 5 absorbs half of the ambient light, thus the reflectance that the ambient light reaches the exterior through the second polarizer 5 and the cover lens 7 is about 2%; (3) then the ambient light passes through the gap 4 to contacts with the touch panel 6 on the display panel 3 to generate the third reflection, assuming there's depolarization, half of the reflection is absorbed by the second polarizer 5, then reaches to the exterior through the cover lens 7, if the second polarizer 5 is linear polarizer, then the reflectance toward the exterior is about 1%. If the second polarizer 5 is circular polarizer, assuming no depolarization of third reflection, then the reflectance toward the exterior is about 0%.

Please refer to FIG. 10. (1) the ambient light contacts with the cover lens 7 through the air first with the reflectance of about 4%; (2) then the ambient light enters the second polarizer 5, and the gap 4 (air gap), because the second polarizer 5 absorbs half of the ambient light, thus the reflectance that the ambient light reaches the exterior through the second polarizer 5 and the cover lens 7 is about 2%; (3) then the ambient light passes through the gap 4 to contact with the display panel 3 to generate the third reflection, assuming there's depolarization, half of the reflection is absorbed by the second polarizer 5, then reaches to the exterior through the cover lens 7, if the second polarizer 5 is linear polarizer, then the reflectance toward the exterior is about 1%. If the second polarizer 5 is circular polarizer, assuming no depolarization of third reflection, then the reflectance toward the exterior is about 0%.

In sum, the invention changes the position of the second polarizer 5 from on the display panel 3 to on the gap 4, but the direction of the absorption axis remains unchanged, thus there is no generated impact on the display effect which make the optical properties consistent. Whereas, there is an additional polarizer on the reflection path within the air gap which effectively reduces the whole reflectance and thus make the optical properties of the invention better than that of the traditional air bonding touch display apparatus.

Further, the strength of the touch display apparatus is proportional to its thickness, the combination of the second polarizer 5 and the touch panel 6 will increase the thickness to improve its strength, especially when measured in the Drop Ball Test.

The second polarizer 5 of the invention can take the place as an anti-scattering film (ASF). When the touch panel 6 in the air bonding touch display apparatus is composed with fragile OGS (one glass solution) or TOL (Touch on lens), it is generally necessary to adhere an ASF to avoid splashing in colliding. The structure of the touch panel 6 with the polarizer adhered below can take place of the ASF for cost reduction.

In FIG. 3 to FIG. 10, in the strong ambient light environment, the reflectance of the invention is 4%+2%+(0-1%)=6-7%, and the 6-7% reflectance of the washing out is less than twice the 4% reflectance of the directing bonding. The invention can preferably solve the problem of the poor outdoor visibility of the air bonding touch display apparatus in the prior art.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch display apparatus comprising:
a first polarizer;
a display panel disposed on the first polarizer;
a gap disposed on the display panel; and
a second polarizer disposed on the gap.

2. The touch display apparatus as claim 1, wherein the first polarizer comprises a first polarizing direction, the second polarizer comprises a second polarizing direction, the first polarizing direction is aligned with the second polarizing direction to show an image.

3. The touch display apparatus as claim 1, further comprising a touch panel disposed on the second polarizer, wherein the touch panel comprises at least a substrate and a sensor disposed on the substrate.

4. The touch display apparatus as claim 3, wherein the sensor comprises a transparent conductive electrode made of ITO, IZO, silver nanomaterial, metal mesh, or carbon nanotube, wherein the substrate is made of optically transparent, low retardation, or zero retardation material comprising ITO Glass, Arton film, PC Film, glass, COP, COC, PC, PMMA, PI, PEN, PET, or TAC.

5. The touch display apparatus as claim 1, further comprising a touch panel disposed between the gap and the second polarizer, wherein the touch panel comprises at least a substrate and a sensor disposed on the substrate.

6. The touch display apparatus as claim 5, wherein the sensor comprises a transparent conductive electrode made of ITO, IZO, silver nanomaterial, metal mesh, or carbon nanotube, wherein the substrate is made of optically transparent, low retardation, or zero retardation material comprising ITO Glass, Arton film, PC Film, glass, COP, COC, PC, PMMA, PI, PEN, PET, or TAC.

7. The touch display apparatus as claim 1, further comprising a cover lens disposed on the outermost surface of the touch display apparatus with respect to the first polarizer, wherein the cover lens is a glass, a protecting film, a plastic film, or a plastic plate.

8. The touch display apparatus as claim 3, further comprising a cover lens disposed on the outermost surface of the touch display apparatus with respect to the first polarizer, wherein the sensor is disposed between the cover lens and the substrate.

9. The touch display apparatus as claim 3, further comprising a cover lens disposed on the outermost surface of the touch display apparatus with respect to the first polarizer, wherein the sensor is disposed between the second polarizer and the substrate.

10. The touch display apparatus as claim 5, further comprising a cover lens disposed on the outermost surface of the touch display apparatus with respect to the first polarizer, wherein the sensor is disposed between the second polarizer and the substrate.

11. The touch display apparatus as claim 5, further comprising a cover lens disposed on the outermost surface of the touch display apparatus with respect to the first polarizer, wherein the sensor is disposed between the gap and the substrate.

12. The touch display apparatus as claim 1, further comprising a touch panel disposed on the second polarizer, wherein the touch panel is a sensor, and the sensor disposed on the surface of the second polarizer with the second polarizer as a substrate.

13. The touch display apparatus as claim 12, wherein the sensor comprises a transparent conductive electrode made of ITO, IZO, silver nanomaterial, metal mesh, and carbon nanotube.

14. The touch display apparatus as claim 1, further comprising a touch panel disposed between the gap and the second polarizer, wherein the touch panel is a sensor, and the sensor disposed on the surface of the second polarizer with the second polarizer as a substrate.

15. The touch display apparatus as claim 14, wherein the sensor comprises a transparent conductive electrode made of ITO, IZO, silver nanomaterial, metal mesh, and carbon nanotube.

16. The touch display apparatus as claim 1, further comprising a touch panel disposed between the display panel and the gap.

17. The touch display apparatus as claim 16, wherein the touch panel comprises at least a substrate and a sensor disposed on the substrate, wherein the substrate is made of optically transparent, low retardation, or zero retardation material.

18. The touch display apparatus as claim 16, wherein the touch panel is a sensor, and the sensor disposed on the display panel with the display panel as a substrate.

19. The touch display apparatus as claim 1, further comprising a touch panel disposed inside the display panel, wherein the touch panel is a sensor, and the sensor is integrated inside the display panel.

20. An electric apparatus comprising the touch display apparatus as claim 1.
